(19) United States
(12) Patent Application Publication
(10) Pub. No.: US 2026/0353341 A1
(43) Pub. Date: Nov. 5, 2026

(54) REMOTE UE POSITIONING

(71) Applicant: QUALCOMM Incorporated, San Diego, CA (US)

(72) Inventor: Avinash SHRIVASTAVA, Hyderabad (IN)

(21) Appl. No.: 19/199,241

(22) Filed: May 5, 2025

(51) Int. Cl. H04W 64/00; H04W 8/22; H04W 76/20; H04W 92/18

(52) U.S. Cl. CPC H04W 64/00; H04W 8/22; H04W 76/20; H04W 92/18

(57) ABSTRACT

Aspects presented herein may enhance user-to-network (U2N) remote user equipment (UE) positioning capabilities by introducing additional/dedicated information elements (IEs) in capability messages, such as relay UE information, remote UE connection status, etc., to provide more detailed information to a location server for accurate positioning. For example, in one aspect of the present disclosure, a first UE transmits, to a network entity, an indication of at least one of: (1) location information related to a second user equipment (UE), (2) a connection status of the first UE, (3) a device type of the first UE, (4) a radio frequency (RF) status of the first UE, (5) a radio access technology (RAT) status of the first UE, or (6) information related to other sidelink UEs or remote UEs. The first UE receives, from the network entity based on the indication, a set of configurations related to positioning of the first UE.

### TECHNICAL FIELD

The present disclosure relates generally to communication systems, and more particularly, to wireless communication involving positioning and sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a network entity, an indication of at least one of: (1) location information related to a second user equipment (UE), (2) a connection status of the first UE, (3) a device type of the first UE, (4) a radio frequency (RF) status of the first UE, (5) a radio access technology (RAT) status of the first UE, or (6) information related to other sidelink UEs or remote UEs. The apparatus receives, from the network entity based on the indication, a set of configurations related to positioning of the first UE.

In an aspect of the disclosure, a method, a computer-readable medium, and an apparatus are provided. The apparatus receives an indication of at least one of: (1) location information related to a second UE, (2) a connection status of a first UE, (3) a device type of the first UE, (4) an RF status of the first UE, (5) a RAT status of the first UE, or (6) information related to other sidelink UEs or remote UEs. The apparatus transmits, based on the indication, a set of configurations related to positioning of the first UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements (which may also be referred to as “network-based positioning”) in accordance with various aspects of the present disclosure.

FIG. 5A is a diagram illustrating an example scenario where a remote UE is able to communicate with a base station directly or via a relay UE in accordance with various aspects of the present disclosure.

FIG. 5B is a diagram illustrating an example scenario where a remote UE is configured to communicate with a base station via a relay UE as the remote UE is unable to communicate directly with the base station in accordance with various aspects of the present disclosure.

FIG. 6 is a diagram illustrating an example of a user-to-network (U2N) remote UE indication in accordance with various aspects of the present disclosure.

FIG. 7 is a communication flow illustrating an example of a remote UE providing various information elements (IEs) to a location server to enhance the U2N remote UE positioning of the remote UE in accordance with various aspects of the present disclosure.

FIG. 8 is a communication flow illustrating an example communication between a location management function (LMF) and an NG-RAN node for UE positioning in accordance with various aspects of the present disclosure.

FIG. 9 is a diagram illustrating an example of relay parameters in accordance with various aspects of the present disclosure.

FIG. 10 is a flowchart of a method of wireless communication.

FIG. 11 is a diagram illustrating an example of a hardware implementation for an example apparatus and/or network entity.

FIG. 12 is a flowchart of a method of wireless communication.

FIG. 13 is a diagram illustrating an example of a hardware implementation for an example network entity.

### DETAILED DESCRIPTION

Aspects presented herein may improve the overall performance of positioning, such as the network-based positioning that involves using a relay user equipment (UE). For example, aspects presented herein may enhance user-to-network (U2N) remote UE positioning capabilities by introducing additional/dedicated information elements (IEs) in the capability messages, such as relay UE information, remote UE connection status, etc., to provide more detailed information to a location server (e.g., a location management function (LMF)) for accurate positioning. Aspects presented herein may also enable the location server to utilize the positioning communication protocol, such as the NR Positioning Protocol A (NRPPa), to gather comprehensive U2N remote UE capabilities and operations details from an Access and Mobility Management Function (AMF) to optimize positioning operations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

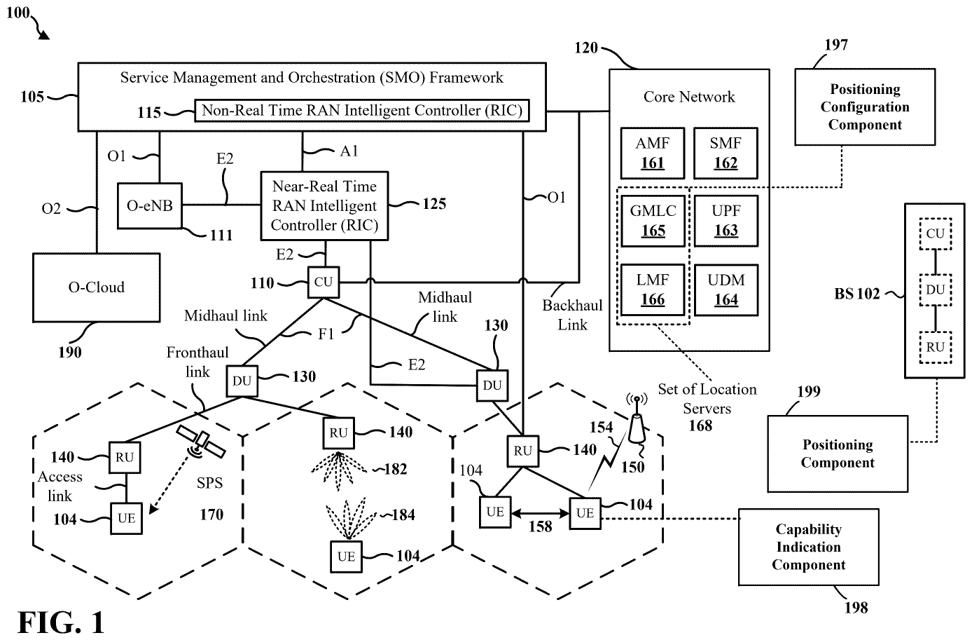

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, the network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a capability indication component 198 that may be configured to transmit, to a network entity, an indication of at least one of: (1) location information related to a second UE, (2) a connection status of the first UE, (3) a device type of the first UE, (4) an RF status of the first UE, (5) a RAT status of the first UE, or (6) information related to other sidelink UEs or remote UEs; and receive, from the network entity based on the indication, a set of configurations related to positioning of the first UE. In certain aspects, the one or more location servers 168 may have a positioning configuration component 197 that may be configured to receive an indication of at least one of: (1) location information related to a second UE, (2) a connection status of a first UE, (3) a device type of the first UE, (4) an RF status of the first UE, (5) a RAT status of the first UE, or (6) information related to other sidelink UEs or remote UEs; and transmit, based on the indication, a set of configurations related to positioning of the first UE. In certain aspects, the base station 102 may have a positioning component 199 that may be configured to assist the UE 104 with the positioning.

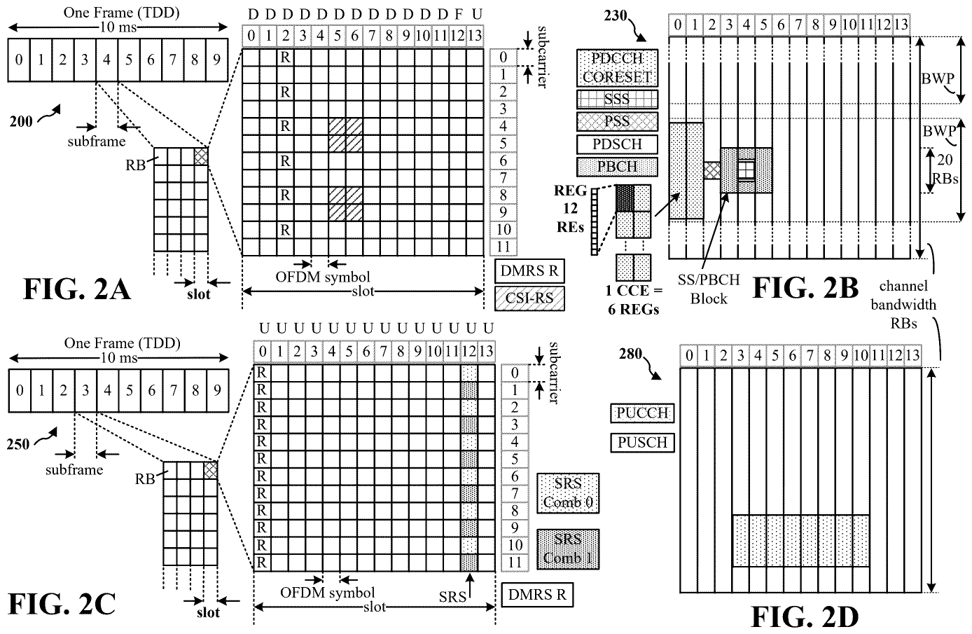

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

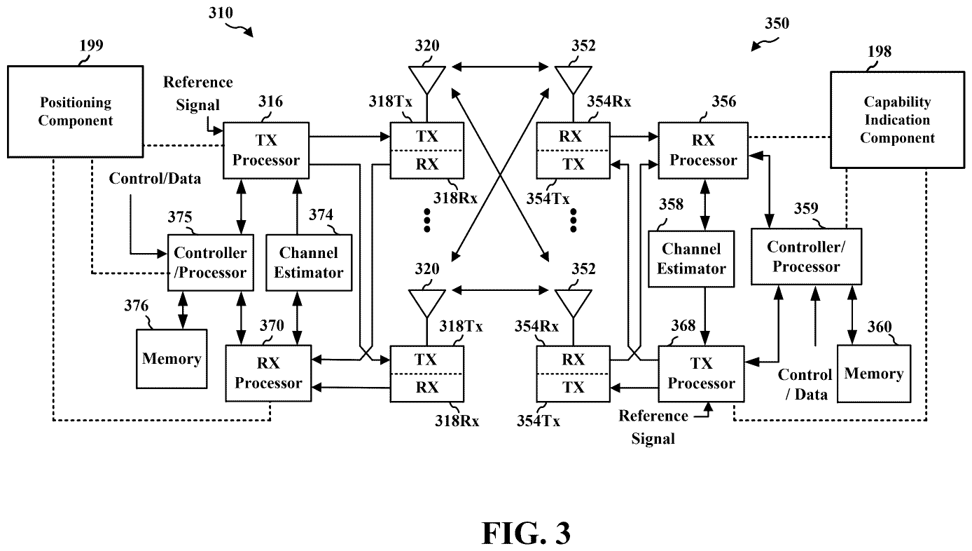

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the capability indication component 198 of FIG. 1.

At least one of the TX processor 316, the RX processor 370, and the controller/processor 375 may be configured to perform aspects in connection with the positioning component 199 of FIG. 1.

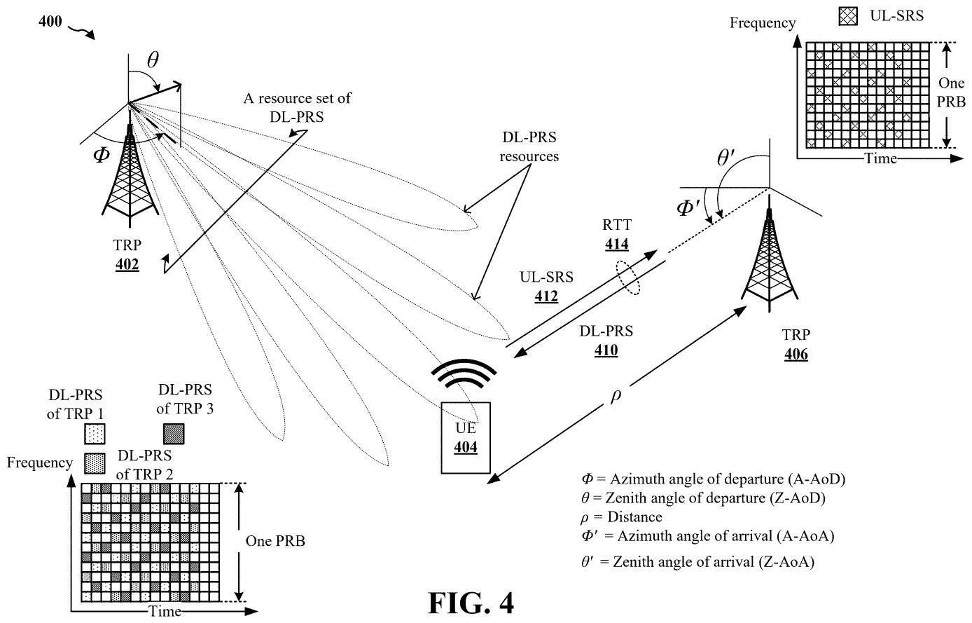

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}|. Accordingly, multi-RTT positioning may make use of the UE Rx−Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx−Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx−Tx time difference measurements (and/or DL PRS-RSRP of the received signals) using assistance data received from the positioning server, and the TRPs 402, 406 measure the gNB Rx−Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx−Tx time difference” may be defined as T_{UE-RX}−T_{UE-TX}, where: T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{UE-RX} measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubframeRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements

“DL reference signal carrier phase (RSCP)” is defined as the phase of the channel response at the 1^{st} path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP) j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

In some network implementations, a first UE may have the capability to communicate with a base station/TRP directly, or via a second UE. When the first UE is communicating with the base station/TRP via the second UE, the first UE may be referred to as a remote UE, and the second UE may be referred to as a relay UE. For purposes of the present disclosure, a relay UE may refer to a UE that is configured to transmit/forward data/signal received from another UE to a base station/TRP and/or transmit/forward data/signal received from the base station/TRP to the another UE. A relay UE may assist in extending the coverage or capacity of a cellular network by acting as an intermediary between the base station and other UEs, helping to relay data/signals to areas with poor coverage or high traffic. A remote UE may refer to a UE that is located remotely from a (main/serving) base station or the core network, where the UE may not be able to establish a direct communication with the base station or the core network. An example scenario may include a remote UE connecting to the network from a location that is geographically separate or distant from the primary network infrastructure.

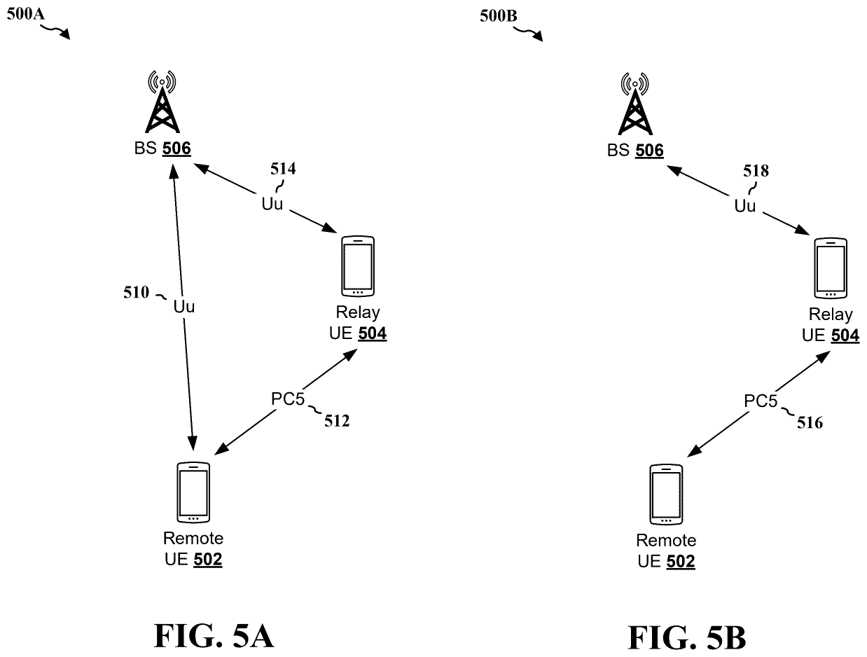

FIG. 5A is a diagram 500A illustrating an example scenario where a remote UE is able to communicate with a base station directly or via a relay UE in accordance with various aspects of the present disclosure. As shown at 510, when a remote UE 502 is within the (cellular) coverage of a base station 506 (or a TRP of the base station 506), the remote UE 502 may communicate directly with the base station 506, such as via a Uu link.

In some scenarios, the remote UE 502 may be configured to communicate with the base station 506 via a relay UE 504 (even when the remote UE 502 is able to communicate directly with the base station 506). For example, there may be an atmospheric and/or environmental interference between the remote UE 502 and the base station 506, where data/signal transmission between the remote UE 502 and the base station 506 may be improved through the relay UE 504. In such scenarios, as shown at 512 and 514, the remote UE 502 may transmit data/signal to the relay UE 504 (e.g., via a PC5 link), and the relay UE 504 may transmit/forward the received data/signal to the base station 506 (e.g., via a Uu link). Similarly, the base station 506 may transmit data/signal to the relay UE 504 (e.g., via the Uu link), and the relay UE 504 may transmit/forward the received data/signal to the remote UE 502 (e.g., via the PC5 Uu link).

In some examples, the remote UE 502 may be configured to improve the transmission speed and/or reliability based on link diversity, where the remote UE 502 may connect the base station 506 through multiple links (or connections). For example, the remote UE 502 may employ a dual connectivity technique by simultaneously connecting to the base station 506 directly (e.g., through RRC connection) and indirectly (e.g., through the relay UE 504 using a sidelink connection).

Also, in some implementations, when the remote UE 502 is able to directly communicate with the base station 506, the remote UE 502 may be specified/configured to synchronize with the synchronization signal block (SSB) signals from the base station 506 (otherwise, the remote UE 502 may be specified/configured to synchronize with other SSB signals).

FIG. 5B is a diagram 500B illustrating an example scenario where a remote UE is configured to communicate with a base station via a relay UE as the remote UE is unable to communicate directly with the base station in accordance with various aspects of the present disclosure. In some scenarios, the remote UE 502 may be configured to communicate with the base station 506 via a relay UE 504 because the remote UE 502 is unable to establish a direct communication (e.g., a Uu link) with the base station 506. In such scenarios, as shown at 516 and 518, the remote UE 502 may transmit data/signal to the relay UE 504 (e.g., via a PC5 link), and the relay UE 504 may transmit/forward the received data/signal to the base station 506 (e.g., via a Uu link). Similarly, the base station 506 may transmit data/signal to the relay UE 504 (e.g., via the Uu link), and the relay UE 504 may transmit/forward the received data/signal to the remote UE 502 (e.g., via the PC5 Uu link).

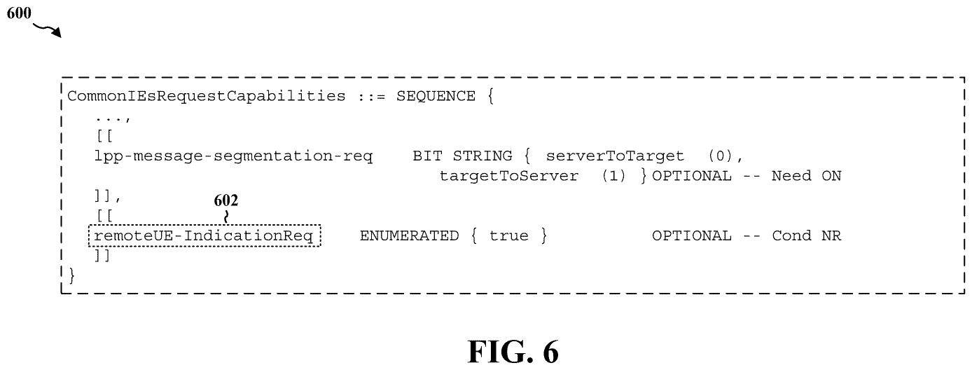

FIG. 6 is a diagram 600 illustrating an example of a user-to-network (U2N) remote UE indication in accordance with various aspects of the present disclosure. In some network implementations, a location server, such as an LMF, may have the capability to ask a UE (which may be referred to as a “target UE” for purpose of illustration/differentiation) whether the target UE is configured for layer 2 (L2) U2N remote UE or not. An L2 U2N communication may refer to a wireless communication mechanism in which a UE communicates with the network via the L2 relay-based connectivity instead of directly using an Uu interface (i.e., communicating via a relay UE).

In response, as shown at 602, the target UE may provide/update its remote UE related information to the location server, such as via a provide capability message. For example, the provide capability message may include an information element (IE) “remoteUE-Indication” (e.g., as part of CommonIEsProvideCapabilities or an IE dedicated to remote UE capability) that indicates whether the target UE in NR access is configured as a L2 U2N remote UE. The target UE in NR access may transmit a ProvideCapabilities message with an appropriate value of this field when it starts or stops operation as a U2N remote UE. However, the target UE may not provide more information in this provide capability message when the target UE starts/stop working as a U2N remote UE. There may be many other useful information which are beneficial for the location server when the target UE works as a U2N remote UE. For purposes of the present disclosure, positioning that involves using a relay UE may be referred to as the “U2N remote UE positioning.” For example, for network-based positioning as described in connection with FIG. 4, if the UE 404 is configured to perform the positioning using at least one relay UE (e.g., the UE 404 receives PRS(s) from a base station/TRP via a relay UE and/or transmits SRS(s) to a base station/TRP via a relay UE), such positioning may be referred to as the U2N remote UE positioning.

Aspects presented herein may improve the overall performance of positioning, such as the network-based positioning that involves using a relay UE. For example, aspects presented herein may enhance U2N remote UE positioning capabilities by introducing additional/dedicated IEs in the capability messages (e.g., remote UE capability messages, such as using the remoteUE-Indication IE within the CommonIEsProvideCapabilities as discussed in connection with FIG. 6), such as relay UE information, remote UE connection status, etc., to provide more detailed information to a location server (e.g., an LMF) for accurate positioning. Aspects presented herein may also enable the location server to utilize the positioning communication protocol, such as the NR Positioning Protocol A (NRPPa), to gather comprehensive U2N remote UE capabilities and operations details from an Access and Mobility Management Function (AMF) to optimize positioning operations.

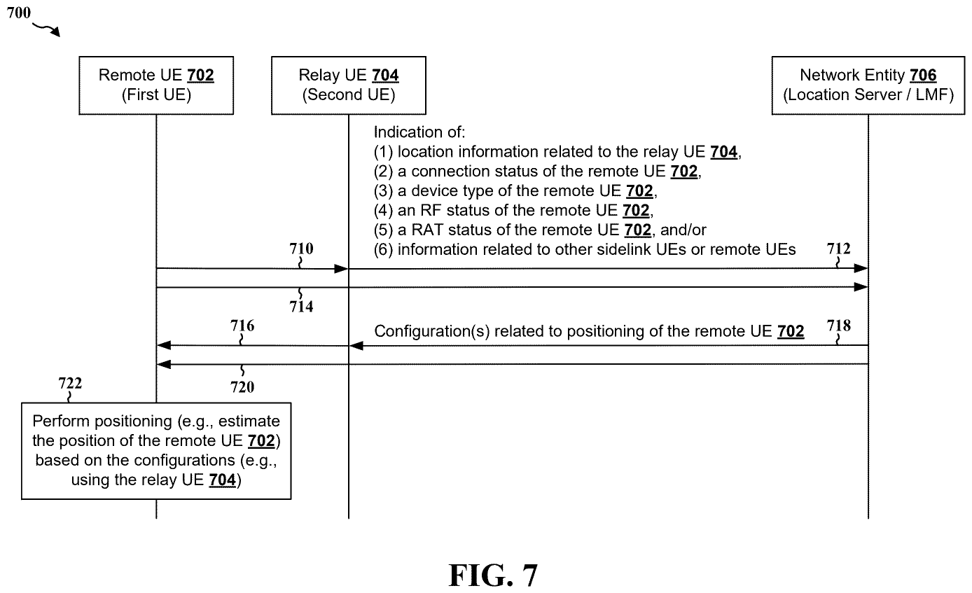

FIG. 7 is a communication flow 700 illustrating an example of a remote UE providing various IEs to a location server to enhance the U2N remote UE positioning of the remote UE in accordance with various aspects of the present disclosure. The numberings associated with the communication flow 700 do not specify a particular temporal order and are merely used as references for the communication flow 700. In one aspect of the present disclosure, a (target) UE may be configured to provide an enhanced “RemoteUE-Indication” provide capability message that includes (additional/rich) information/IEs that is capable of enhancing U2N remote UE positioning when the UE works as a U2N remote UE. The information/IEs discussed below may provide an improved/clearer picture to a location server for selecting further or most suitable positioning operation(s).

As an illustration, at 710, 712, and/or 714, a remote UE 702 (e.g., a first UE) may transmit, to a network entity 706 (e.g., a location server, an LMF, etc.), an indication that includes at least one of: (1) location information related to a relay UE 704, (2) a connection status of the remote UE 702, (3) a device type of remote UE 702, (4) a radio frequency (RF) status of the remote UE 702, (5) a radio access technology (RAT) status of the remote UE 702, or (6) information related to other sidelink UEs or remote UEs, etc. As shown at 710 and 712, the remote UE 702 may transmit the indication indirectly to the network entity 706 via the relay UE 704, or directly to the network entity 706 as shown at 714.

The (1) location information related to a relay UE 704, which may be denoted by an IE “U2N_RelayUE_Info” for purposes of illustration, may include/provide location-related information of the relay UE 704. For example, when a target UE (e.g., the remote UE 702) works as a U2N remote UE, the target UE may already have a connection with a relay UE (e.g., the relay UE 704) (e.g., via a PC5 link) and/or with a base station/TRP (e.g., via a Uu link), such as described in connection with FIGS. 5A and 5B. It may be useful for the network entity 706 to know the location-related information of the relay UE 704 as it may enable the network entity 706 to configure/estimate the positioning session of the remote UE 702 more appropriately. For example, by knowing the (precise/estimated/coarse) location of the relay UE 704, the network entity 706 may estimate the location of the remote UE 702 more accurately, or provide positioning related configuration(s) that are more suitable for the remote UE 702.

Depending on implementations, the location-related information of the relay UE 704 (i.e., the U2N_RelayUE_Info IE) may include the current location of the relay UE 704 (e.g., a specified area such as a specified address, building, landmark, etc.), a physical cell ID (e.g., 5G and/or 6G RAT) associated with the relay UE 704, a cell identity associated with the relay UE 704, an E-UTRA absolute radio frequency channel number (EARFCN) associated with the relay UE 704, and/or the latitude and longitude coordinates of the relay UE 704, etc. The relay UE 704 may advertise the aforementioned location information to the remote UE 702, such as via sidelink (SL) discovery message(s). In some examples, the same information (i.e., the location-related information of the relay UE 704) may also be passed to the network entity 706 under the U2N remote UE capability message as both the relay UE 704 and the remote UE 702 may be very close to each other and these additional information may work as a coarse/reference position for the remote UE 702 (e.g., serving as the U2N remote UE).

The (2) connection status of the remote UE 702, which may be denoted by an IE “U2N_RemoteUE_Connection_Status” for purposes of illustration, may indicate the radio resource control (RRC) connection status of the remote UE 702, such as whether the remote UE 702 is (currently) under an RRC idle mode, an RRC connected mode, or is under a sleeping mode with signaling type which is Uu (e.g., when the remote UE 702 has a connectivity with a base station/gNB) or PC5 (e.g., when the remote UE has a connection with a relay UE) interface. It may be important for the network entity 706 to know the connection status of the remote UE 702 because sometimes the relay UE 704 may go into an RRC idle/inactive state. As this may impact the U2N remote UE positioning session, it may be important for the network entity 706 to know the connection status of the remote UE 702, such that the network entity 706 may decide further 5G/6G cell(s) to be used for the positioning and/or manage the secure user plane location (SUPL) call flows. As discussed in connection with FIG. 4, some network-based (e.g., 5G/6G cell based) positioning may work in the RRC idle mode by just taking measurement(s) at the physical layer.

The (3) device type of remote UE 702, which may be denoted by an IE “U2N_RemoteUE_Type” for purposes of illustration, may indicate the type of device of the remote UE 702. When a target UE (e.g., the remote UE 702) works as a U2N remote UE, the target UE may inform its device type in a provide capability message, such as whether the target UE/U2N remote UE is a mobile device, a reduced capability (RedCap) device, a wearable device, an internet-of-things (IoT) device, an automotive, or an unmanned aerial vehicle (UAV), etc. It may be important for the network entity 706 to know the device type of remote UE 702 because U2N relay and remote technology may be based on sidelink which is most commonly used in cellular vehicle-to-everything (CV2X). By knowing the device type of the remote UE 702, the network entity 706 may provide corresponding/suitable positioning configuration(s) for the remote UE 702 based on its device type. For example, if the remote UE 702 is a mobile phone, then the network entity 706 may provide positioning parameters that are suitable for (that are able to be achieved/performed by) the mobile phone.

The (4) RF status of the remote UE 702, which may be denoted by an IE “U2N_RemoteUE_RF_Status” for purposes of illustration, may provide the RF signal strength of the remote UE 702 (e.g., the RF signal strength between the remote UE 702 and the relay UE 704), such as the reference signals received power (RSRP), the signal-to-noise ratio (SNR), the received signal strength indication (RSSI), and/or the channel state information (CSI) corresponding to the relay UE 704. It may be important for the network entity 706 to know the RF status of the remote UE 702 because U2N relays may be an important technology for extending network coverage to remote areas, which may be important for situational awareness and mission delivery. By knowing the RF signal strength between the remote UE 702 and the relay UE 704, the network entity 706 may determine more appropriate positioning configuration(s) for the positioning session, such as whether to continue to use the relay UE 704 for the positioning, or whether to apply offset(s) to the positioning measurements, etc.

The (5) RAT status of the remote UE 702, which may be denoted by an IE “U2N_RemoteUE_RAT_Status” for purposes of illustration, may indicate whether the remote UE 702 supports higher RAT(s) or not. In some scenarios, as the relay UE 704 may be served with a specified RAT (e.g., with just 5G NR), it may be beneficial for the network entity 706 to know whether the remote UE 702 supports a higher RAT version (compared to the relay UE 704) along with the camped RAT information (e.g., FR1, FR2, RedCap (20 Mhz), or via Non-terrestrial networks (NTN), etc.). Thus, the network entity 706 may configure other relay UE(s) for the remote UE 702 that also support the higher RAT version to improve the positioning session. Also, it may be useful for the network entity 706 to know the RAT status of the remote UE 702 because different devices may run on different modes to get wireless (e.g., 5G/6G) access.

The (6) information related to other sidelink UEs or remote UEs, which may be denoted by an IE “U2N_RemoteUE_ActiveSidelink connection_Info” for purposes of illustration, may enable the network entity 706 to know information related to the UE(s) that are in proximity to the remote UE 702. If a target UE (e.g., the remote UE 702) works as a U2N remote UE mode, the target UE may know and report information related to other nearby remote UE(s) to the network entity 706 as the target UE may have surrounding UE/device information due to sidelink discovery message. This information may be beneficial as it enables the network entity 706 to generate a coverage map from the same location.

At 716, 718, and/or 720, based on the indication received from the remote UE 702 as discussed above, the network entity 706 may provide, to the remote UE 702, a set of configurations related to the positioning of the remote UE 702. As shown at 716 and 718, the network entity 706 may transmit the set of configurations indirectly to the remote UE 702 via the relay UE 704, or directly to the remote UE 702 as shown at 720. In addition, the network entity 706 may transmit the set of configurations to the remote UE 702 via assistance data (AD).

At 722, the remote UE 702 may perform positioning (e.g., estimate the position of the remote UE 702) based on the set of configurations (and also perform the positioning using the relay UE 704).

In another aspect of the present disclosure, the network entity 706 (e.g., a location server, an LMF, etc.) may also be configured to obtain (additional/updated) capability information of the remote UE 702 (e.g., the IEs discussed in connection with 710, 712, and 714) from an access and mobility management function (AMF) (e.g., a 5G AMF), such as via NRPPa protocol. For example, after the network entity 706 obtains the indication at 710, 712, and/or 714 (e.g., via a provide capability message) from the remote UE 702 (e.g., via LTE Positioning Protocol (LPP) signaling), the network entity 706 may communicate with an AMF (e.g., via NRPPa signaling) to obtain additional and/or updated capability information of the remote UE 702 (e.g., the U2N remote UE capabilities) and sidelink operation details, e.g., the AMF may have already stored (all of) the U2N remote UE capabilities and operations details during sidelink procedure and discovery messages.

After the network entity 706 gathers the relevant information from the AMF, the network entity 706 may decide a most suitable positioning method for the remote UE 702. For example, as a relay UE (e.g., the relay UE 704) may be configured to run on a maximum transmission (Tx) power and serve all services to a remote UE (e.g., the remote UE 702), there may be a chance that the device battery of the relay UE goes down that may impact the service(s) provided by the relay UE. As such, if the network entity 706 is able to obtain the power/battery information of the relay UE (e.g., from the remote or directly from the relay UE), the network entity 706 may choose most suitable/best power saving methods for the remote UE as the remote UE connection may lose any time with the relay UE. Similarly, the network entity 706 may also utilized the battery percentage information of the remote UE and/or the channel bandwidth information to determine a most suitable positioning method and/or power configuration for the remote UE 702. Also, the relay UE may have the capability to transfer its task(s) to other candidate relay UE(s) after getting indications from a base station. As such, the network entity 706 may obtain real live updates from AMF about the remote UE 702. In other words, the network entity 706 may get more detailed information from the AMF via NRPPa protocol about the remote UE 702 and other useful information which might be useful for positioning purpose.

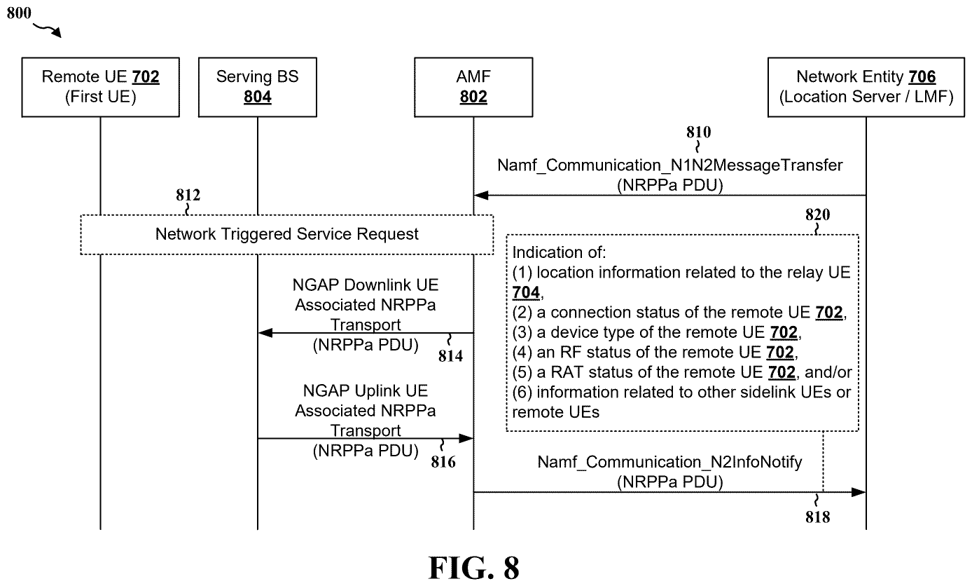

FIG. 8 is a communication flow 800 illustrating an example communication (e.g., NRPPa PDU transfer) between an LMF (e.g., the network entity 706) and an NG-RAN node (e.g., a base station) for UE positioning in accordance with various aspects of the present disclosure. The numberings associated with the communication flow 800 do not specify a particular temporal order and are merely used as references for the communication flow 800.

In one example, the communications/signaling shown at 810, 812, and 814 may be triggered when the network entity 706 (e.g., an LMF) is specified/configured to send an NRPPa message to the serving base station 804 (e.g., a serving NG-RAN Node) for the remote UE 702 (e.g., a target UE) as part of a NRPPa positioning activity. As shown at 810, network the entity 706 may invoke a Namf_Communication_NIN2MessageTransfer service operation towards an AMF 802 to request the transfer of a NRPPa PDU to the serving base station 804 for the remote UE 702.

At 812, if the remote UE 702 is in an idle state (e.g., if the connection was previously released due to data and signaling inactivity), the AMF 802 may perform a network triggered service request in order to establish a signaling connection with the remote UE 702 and assign a serving base station.

At 814, the AMF 802 may forward the NRPPa PDU to the serving base station 804 in an NGAP downlink UE associated NRPPa transport message over the NG signaling connection corresponding to the remote UE 702 and includes a routing ID related to the network entity 706. The AMF 802 may not retain the state information for this transfer.

The communications/signaling shown at 816 and 820 may be triggered when the serving base station 804 is specified to send an NRPPa message to the network entity 706 for the remote UE 702 as part of an NRPPa positioning activity. As shown at 814, the serving base station 804 may send an NRPPa PDU to the AMF 802 in an NGAP uplink UE associated NRPPa transport message and includes the routing ID received at 814.

At 818, the AMF 802 may invoke a Namf_Communication_N2InfoNotify service operation towards the network entity 706 indicated by the routing ID received at 816. The service operation may include the NRPPa PDU received at 816 together with the LCS Correlation ID in the N2 Info Container. Communications 810 to 818 may be repeated.

As shown at 820, the network entity 706 may obtain (additional/updated) capability information of the remote UE 702 (e.g., including the IEs discussed in connection with 710, 712, and 714 of FIG. 7) from the AMF 802 during this procedure the AMF 802 may have already stored (all of) the U2N remote UE capabilities information of the remote UE 702 and operations details during sidelink procedure and discovery messages.

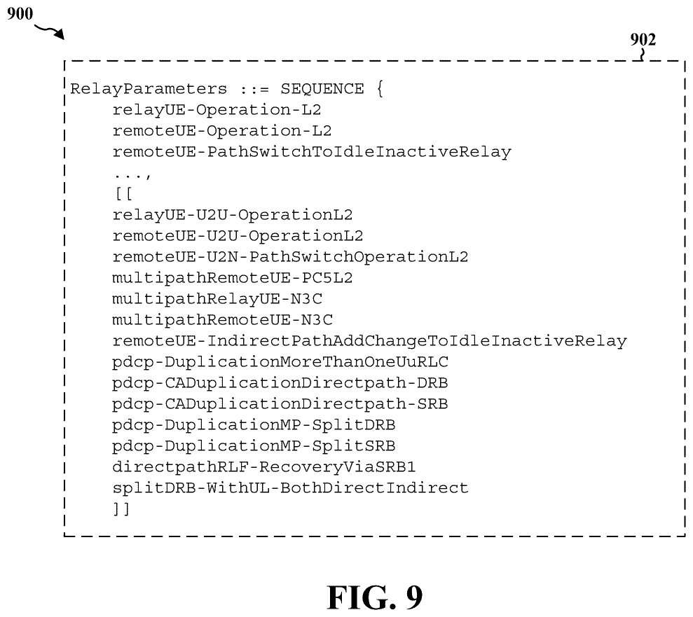

FIG. 9 is a diagram 900 illustrating an example of relay parameters in accordance with various aspects of the present disclosure. In some network implementations, as shown at 902, the network entity 706 may communicate with the AMF 802 various relay parameters related to the remote UE 702 and/or the relay UE 704, such as using an IE “relayparameters” (e.g., this IE/information may be configured to be stored in an AMF when a UE exchanges capabilities messages with a 5G core).

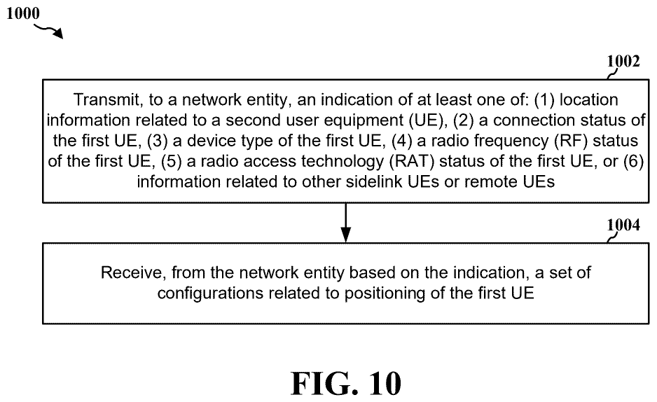

FIG. 10 is a flowchart 1000 of wireless communication. The method may be performed by a first UE (e.g., the UE 104, 404; the remote UE 502, 702; the apparatus 1104). The method may enable the first UE to include additional/dedicated IEs in the capability messages, such as relay UE information, remote UE connection status, etc. to enhance U2N remote UE positioning capabilities and improve the overall performance of positioning.

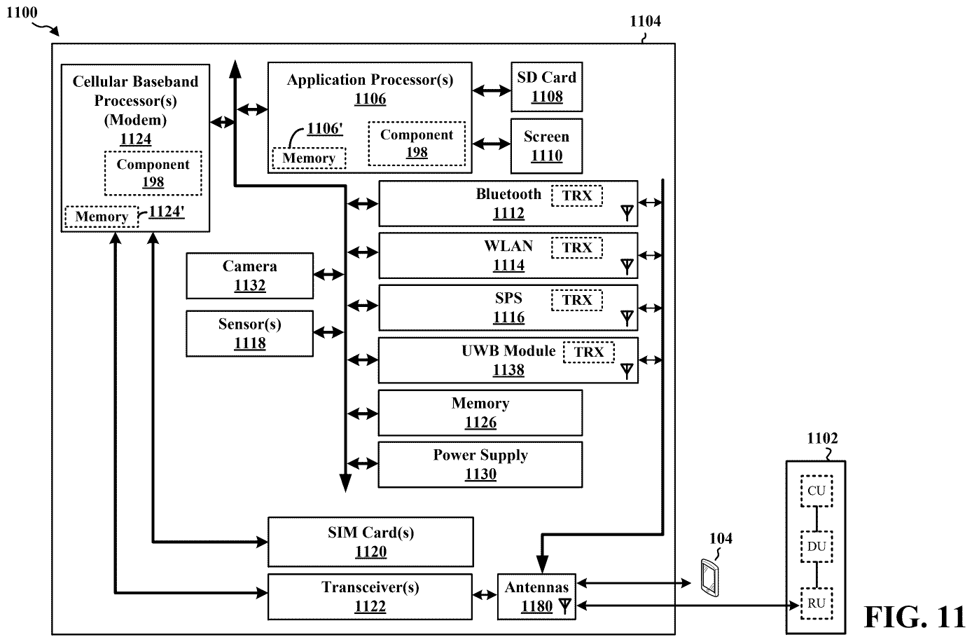

At 1002, the first UE may transmit, to a network entity, an indication of at least one of: (1) location information related to a second UE, (2) a connection status of the first UE, (3) a device type of the first UE, (4) an RF status of the first UE, (5) a RAT status of the first UE, or (6) information related to other sidelink UEs or remote UEs, such as described in connection with FIGS. 7 to 9. For example, as discussed in connection with 710, 712, and 714 of FIG. 7, a remote UE 702 (e.g., a first UE) may transmit, to a network entity 706 (e.g., a location server, an LMF, etc.), an indication that includes at least one of: (1) location information related to a relay UE 704, (2) a connection status of the remote UE 702, (3) a device type of remote UE 702, (4) an RF status of the remote UE 702, (5) a RAT status of the remote UE 702, or (6) information related to other sidelink UEs or remote UEs, etc. As shown at 710 and 712, the remote UE 702 may transmit the indication indirectly to the network entity 706 via the relay UE 704, or directly to the network entity 706 as shown at 714. The transmission of the indication may be performed by, e.g., the capability indication component 198, the transceiver(s) 1122, the cellular baseband processor(s) 1124, and/or the application processor(s) 1106 of the apparatus 1104 in FIG. 11.

At 1004, the first UE may receive, from the network entity based on the indication, a set of configurations related to positioning of the first UE, such as described in connection with FIGS. 7 to 9. For example, as discussed in connection with 716, 718, and 720 of FIG. 7, based on the indication transmitted to the network entity 706, the remote UE 702 may receive, from the network entity 706, a set of configurations related to the positioning of the remote UE 702. The reception of the set of configurations may be performed by, e.g., the capability indication component 198, the transceiver(s) 1122, the cellular baseband processor(s) 1124, and/or the application processor(s) 1106 of the apparatus 1104 in FIG. 11.

In one example, the first UE may further perform the positioning of the first UE based on the set of configurations.

In another example, the first UE corresponds to a remote UE, the second UE corresponds to a relay UE, and the network entity corresponds to an AMF or an LMF.

In another example, the indication includes the location information related to the second UE, and the location information includes at least one of: a set of coordinates of the second UE, a cell ID associated with the second UE, or an EARFCN associated with the second UE.

In another example, the indication includes the connection status of the first UE, and the connection status includes at least one of: an idle state, a connected state, or a sleep state with a specified signaling type.

In another example, the indication includes the device type of the first UE, and the device type includes at least one of: a mobile device, a RedCap device, a wearable device, an IoT device, an automotive, or an UAV.

In another example, the indication includes the RF status of the first UE, and where the RF status includes at least one of: an RSRP associated with the first UE, an SNR associated with the first UE, an RSSI associated with the first UE, or a CSI associated with the first UE.

In another example, the indication includes the RAT status of the first UE, and where the RAT status includes at least one of: a support for a higher RAT compared to the second UE, a set of supported FRs, a support for RedCap device, or a support for NTN.

In another example, to transmit the indication, the first UE may be configured to transmit the indication via a U2N remote UE provide capability message.

In another example, to transmit, to the network entity, the indication, the first UE may be configured to transmit the indication directly to the network entity, or transmit the indication to the network entity via the second UE.

In another example, to receive the set of configurations, the first UE may be configured to receive the set of configurations via assistance data (AD).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an ultrawide band (UWB) module 1138 (e.g., a UWB transceiver), an SPS module 1116 (e.g., GNSS module), one or more sensors 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the UWB module 1138, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the capability indication component 198 may be configured to transmit, to a network entity, an indication of at least one of: (1) location information related to a second UE, (2) a connection status of the first UE, (3) a device type of the first UE, (4) an RF status of the first UE, (5) a RAT status of the first UE, or (6) information related to other sidelink UEs or remote UEs. The capability indication component 198 may also be configured to receive, from the network entity based on the indication, a set of configurations related to positioning of the first UE. The capability indication component 198 may be within the cellular baseband processor(s) 1124, the application processor(s) 1106, or both the cellular baseband processor(s) 1124 and the application processor(s) 1106. The capability indication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for transmitting, to a network entity, an indication of at least one of: (1) location information related to a second UE, (2) a connection status of the first UE, (3) a device type of the first UE, (4) an RF status of the first UE, (5) a RAT status of the first UE, or (6) information related to other sidelink UEs or remote UEs. The apparatus 1104 may further include means for receiving, from the network entity based on the indication, a set of configurations related to positioning of the first UE.

In one configuration, the apparatus 1104 may further include means for performing the positioning of the first UE based on the set of configurations.

In another configuration, the first UE corresponds to a remote UE, the second UE corresponds to a relay UE, and the network entity corresponds to an AMF or an LMF.

In another configuration, the indication includes the location information related to the second UE, and the location information includes at least one of: a set of coordinates of the second UE, a cell ID associated with the second UE, or an EARFCN associated with the second UE.

In another configuration, the indication includes the connection status of the first UE, and the connection status includes at least one of: an idle state, a connected state, or a sleep state with a specified signaling type.

In another configuration, the indication includes the device type of the first UE, and the device type includes at least one of: a mobile device, a RedCap device, a wearable device, an IoT device, an automotive, or an UAV.

In another configuration, the indication includes the RF status of the first UE, and where the RF status includes at least one of: an RSRP associated with the first UE, an SNR associated with the first UE, an RSSI associated with the first UE, or a CSI associated with the first UE.

In another configuration, the indication includes the RAT status of the first UE, and where the RAT status includes at least one of: a support for a higher RAT compared to the second UE, a set of supported FRs, a support for RedCap device, or a support for NTN.

In another configuration, the means for transmitting the indication may include configuring the apparatus 1104 to transmit the indication via a U2N remote UE provide capability message.

In another configuration, the means for transmitting, to the network entity, the indication may include configuring the apparatus 1104 to transmit the indication directly to the network entity, or transmit the indication to the network entity via the second UE.

In another configuration, the means for receiving the set of configurations may include configuring the apparatus 1104 to receive the set of configurations via AD.

The means may be the capability indication component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

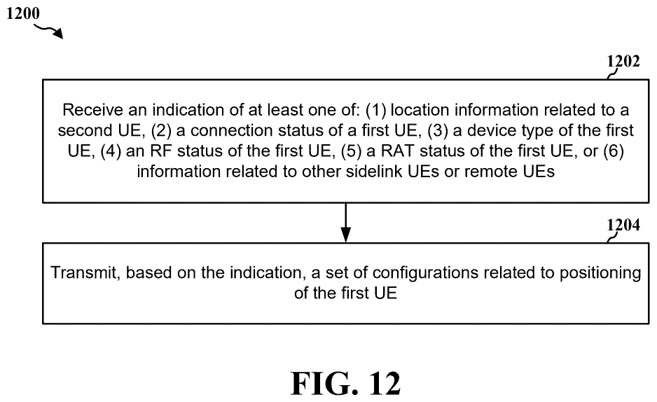

FIG. 12 is a flowchart 1200 of wireless communication. The method may be performed by a network entity (e.g., the one or more location servers 168; the network entity 706, 1360). The method may enable the network entity to obtain additional/dedicated IEs in the capability messages from a remote UE, such as relay UE information, remote UE connection status, etc. to enhance U2N remote UE positioning capabilities and improve the overall performance of positioning.

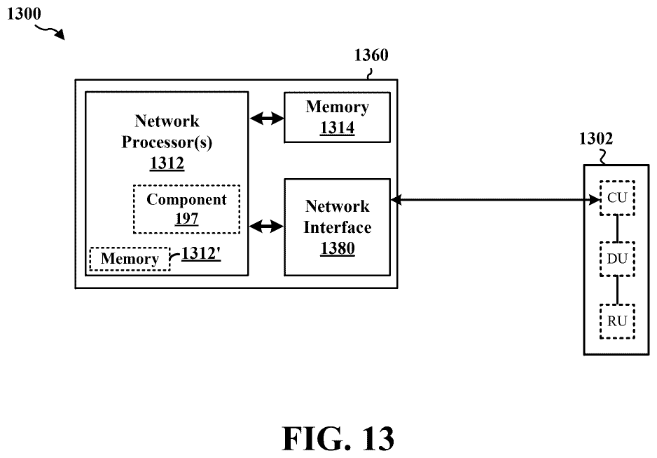

At 1202, the network entity may receive an indication of at least one of: (1) location information related to a second UE, (2) a connection status of a first UE, (3) a device type of the first UE, (4) an RF status of the first UE, (5) a RAT status of the first UE, or (6) information related to other sidelink UEs or remote UEs, such as described in connection with FIGS. 7 to 9. For example, as discussed in connection with 710, 712, and 714 of FIG. 7, a network entity 706 (e.g., a location server, an LMF, etc.) may receive, from a remote UE 702 (e.g., a first UE), an indication that includes at least one of: (1) location information related to a relay UE 704, (2) a connection status of the remote UE 702, (3) a device type of remote UE 702, (4) an RF status of the remote UE 702, (5) a RAT status of the remote UE 702, or (6) information related to other sidelink UEs or remote UEs, etc. As shown at 710 and 712, the remote UE 702 may transmit the indication indirectly to the network entity 706 via the relay UE 704, or directly to the network entity 706 as shown at 714. The reception of the indication may be performed by, e.g., the positioning configuration component 197, the network processor(s) 1312, and/or the network interface 1380 of the network entity 1360 in FIG. 13.

At 1204, the network entity may transmit, based on the indication, a set of configurations related to positioning of the first UE, such as described in connection with FIGS. 7 to 9. For example, as discussed in connection with 716, 718, and 720 of FIG. 7, based on the indication received from the remote UE 702 as discussed above, the network entity 706 may provide, to the remote UE 702, a set of configurations related to the positioning of the remote UE 702. The transmission of the set of configurations may be performed by, e.g., the positioning configuration component 197, the network processor(s) 1312, and/or the network interface 1380 of the network entity 1360 in FIG. 13.

In one example, the first UE corresponds to a remote UE, the second UE corresponds to a relay UE, and the network entity corresponds to an AMF or an LMF.

In another example, the indication includes the location information related to the second UE, and the location information includes at least one of: a set of coordinates of the second UE, a cell ID associated with the second UE, or an EARFCN associated with the second UE.

In another example, the indication includes the connection status of the first UE, and the connection status includes at least one of: an idle state, a connected state, or a sleep state with a specified signaling type.

In another example, the indication includes the device type of the first UE, and the device type includes at least one of: a mobile device, a RedCap device, a wearable device, an IoT device, an automotive, or an UAV.

In another example, the indication includes the RF status of the first UE, and where the RF status includes at least one of: an RSRP associated with the first UE, an SNR associated with the first UE, an RSSI associated with the first UE, or a CSI associated with the first UE.

In another example, the indication includes the RAT status of the first UE, and where the RAT status includes at least one of: a support for a higher RAT compared to the second UE, a set of supported FRs, a support for RedCap device, or a support for NTN.

In another example, to receive the indication, the network entity may be configured to receive the indication from the first UE via a U2N remote UE provide capability message.

In another example, to receive the indication, the network entity may be configured to receive the indication from an AMF.

In another example, to transmit the set of configurations, the network entity may be configured to transmit the set of configurations via AD.

FIG. 13 is a diagram 1300 illustrating an example of a hardware implementation for a network entity 1360. In one example, the network entity 1360 may be within the core network 120. The network entity 1360 may include at least one network processor 1312. The network processor(s) 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The network processor(s) 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the positioning configuration component 197 may be configured to receive an indication of at least one of: (1) location information related to a second UE, (2) a connection status of a first UE, (3) a device type of the first UE, (4) an RF status of the first UE, (5) a RAT status of the first UE, or (6) information related to other sidelink UEs or remote UEs. The positioning configuration component 197 may also be configured to transmit, based on the indication, a set of configurations related to positioning of the first UE. The positioning configuration component 197 may be within the network processor(s) 1312. The positioning configuration component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1360 may include a variety of components configured for various functions. In one configuration, the network entity 1360 may include means for receiving an indication of at least one of: (1) location information related to a second UE, (2) a connection status of a first UE, (3) a device type of the first UE, (4) an RF status of the first UE, (5) a RAT status of the first UE, or (6) information related to other sidelink UEs or remote UEs. The network entity 1360 may further include means for transmitting, based on the indication, a set of configurations related to positioning of the first UE.

In one configuration, the first UE corresponds to a remote UE, the second UE corresponds to a relay UE, and the network entity corresponds to an AMF or an LMF.

In another configuration, the indication includes the location information related to the second UE, and the location information includes at least one of: a set of coordinates of the second UE, a cell ID associated with the second UE, or an EARFCN associated with the second UE.

In another configuration, the indication includes the connection status of the first UE, and the connection status includes at least one of: an idle state, a connected state, or a sleep state with a specified signaling type.

In another configuration, the indication includes the device type of the first UE, and the device type includes at least one of: a mobile device, a RedCap device, a wearable device, an IoT device, an automotive, or an UAV.

In another configuration, the indication includes the RF status of the first UE, and where the RF status includes at least one of: an RSRP associated with the first UE, an SNR associated with the first UE, an RSSI associated with the first UE, or a CSI associated with the first UE.

In another configuration, the indication includes the RAT status of the first UE, and where the RAT status includes at least one of: a support for a higher RAT compared to the second UE, a set of supported FRs, a support for RedCap device, or a support for NTN.

In another configuration, the means for receiving the indication may include configuring the network entity 1360 to receive the indication from the first UE via a U2N remote UE provide capability message.

In another configuration, the means for receiving the indication may include configuring the network entity 1360 to receive the indication from an AMF.

In another configuration, the means for transmitting the set of configurations may include configuring the network entity 1360 to transmit the set of configurations via AD.

The means may be the positioning configuration component 197 of the network entity 1360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F.

Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first user equipment (UE), comprising: transmitting, to a network entity, an indication of at least one of: (1) location information related to a second UE, (2) a connection status of the first UE, (3) a device type of the first UE, (4) a radio frequency (RF) status of the first UE, (5) a radio access technology (RAT) status of the first UE, or (6) information related to other sidelink UEs or remote UEs; and receiving, from the network entity based on the indication, a set of configurations related to positioning of the first UE.

Aspect 2 is the method of aspect 1, further comprising: performing the positioning of the first UE based on the set of configurations.

Aspect 3 is the method of aspect 1 or aspect 2, wherein the first UE corresponds to a remote UE, the second UE corresponds to a relay UE, and the network entity corresponds to an access and mobility management function (AMF) or a location management function (LMF).

Aspect 4 is the method of any of aspects 1 to 3, wherein the indication includes the location information related to the second UE, and wherein the location information includes at least one of: a set of coordinates of the second UE, a cell identification (ID) associated with the second UE, or an E-UTRA absolute radio frequency channel number (EARFCN) associated with the second UE.

Aspect 5 is the method of any of aspects 1 to 4, wherein the indication includes the connection status of the first UE, and wherein the connection status includes at least one of: an idle state, a connected state, or a sleep state with a specified signaling type.

Aspect 6 is the method of any of aspects 1 to 5, wherein the indication includes the device type of the first UE, and wherein the device type includes at least one of: a mobile device, a reduced capability (RedCap) device, a wearable device, an Internet of Things (IoT) device, an automotive, or an unmanned aerial vehicle (UAV).

Aspect 7 is the method of any of aspects 1 to 6, wherein the indication includes the RF status of the first UE, and wherein the RF status includes at least one of: a reference signal received power (RSRP) associated with the first UE, a signal-to-noise ratio (SNR) associated with the first UE, a received signal strength indicator (RSSI) associated with the first UE, or a channel state information (CSI) associated with the first UE.

Aspect 8 is the method of any of aspects 1 to 7, wherein the indication includes the RAT status of the first UE, and wherein the RAT status includes at least one of: a support for a higher RAT compared to the second UE, a set of supported frequency ranges (FRs), a support for reduced capability (RedCap) device, or a support for non-terrestrial networks (NTN).

Aspect 9 is the method of any of aspects 1 to 8, wherein transmitting the indication comprises: transmitting the indication via a user-to-network (U2N) remote UE provide capability message.

Aspect 10 is the method of any of aspects 1 to 9, wherein transmitting, to the network entity, the indication comprises: transmitting the indication directly to the network entity, or transmitting the indication to the network entity via the second UE.

Aspect 11 is the method of any of aspects 1 to 10, wherein receiving the set of configurations comprises: receiving the set of configurations via assistance data (AD).

Aspect 12 is the method of any of aspects 1 to 11, wherein the indication includes at least: (2) the connection status of the first UE and (3) the device type of the first UE.

Aspect 13 is the method of any of aspects 1 to 12, wherein the indication includes at least: (4) the RF status of the first UE and (5) the RAT status of the first UE.

Aspect 14 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 13.

Aspect 15 is the apparatus of aspect 14, further including at least one transceiver coupled to the at least one processor.

Aspect 16 is an apparatus for wireless communication at a first user equipment (UE) including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

Aspect 18 is a method of wireless communication at a network entity, comprising: receiving an indication of at least one of: (1) location information related to a second user equipment (UE), (2) a connection status of a first UE, (3) a device type of the first UE, (4) a radio frequency (RF) status of the first UE, (5) a radio access technology (RAT) status of the first UE, or (6) information related to other sidelink UEs or remote UEs; and transmitting, based on the indication, a set of configurations related to positioning of the first UE.

Aspect 19 is the method of aspect 18, wherein the first UE corresponds to a remote UE, the second UE corresponds to a relay UE, and the network entity corresponds to an access and mobility management function (AMF) or a location management function (LMF).

Aspect 20 is the method of aspect 18 or aspect 19, wherein the indication includes the location information related to the second UE, and wherein the location information includes at least one of: a set of coordinates of the second UE, a cell identification (ID) associated with the second UE, or an E-UTRA absolute radio frequency channel number (EARFCN) associated with the second UE.

Aspect 21 is the method of any of aspects 18 to 20, wherein the indication includes the connection status of the first UE, and wherein the connection status includes at least one of: an idle state, a connected state, or a sleep state with a specified signaling type.

Aspect 22 is the method of any of aspects 18 to 21, wherein the indication includes the device type of the first UE, and wherein the device type includes at least one of: a mobile device, a reduced capability (RedCap) device, a wearable device, an Internet of Things (IoT) device, an automotive, or an unmanned aerial vehicle (UAV).

Aspect 23 is the method of any of aspects 18 to 22, wherein the indication includes the RF status of the first UE, and wherein the RF status includes at least one of: a reference signal received power (RSRP) associated with the first UE, a signal-to-noise ratio (SNR) associated with the first UE, a received signal strength indicator (RSSI) associated with the first UE, or a channel state information (CSI) associated with the first UE.

Aspect 24 is the method of any of aspects 18 to 23, wherein the indication includes the RAT status of the first UE, and wherein the RAT status includes at least one of: a support for a higher RAT compared to the second UE, a set of supported frequency ranges (FRs), a support for reduced capability (RedCap) device, or a support for non-terrestrial networks (NTN).

Aspect 25 is the method of any of aspects 18 to 24, wherein receiving the indication comprises: receiving the indication from the first UE via a user-to-network (U2N) remote UE provide capability message.

Aspect 26 is the method of any of aspects 18 to 25, wherein receiving the indication comprises: receiving the indication from an access and mobility management function (AMF).

Aspect 27 is the method of any of aspects 18 to 26, wherein transmitting the set of configurations comprises: transmitting the set of configurations via assistance data (AD).

Aspect 28 is an apparatus for wireless communication at a network entity, including: at least one memory; and at least one processor coupled to the at least one memory and, based at least in part on stored information that is stored in the at least one memory, the at least one processor, individually or in any combination, is configured to implement any of aspects 18 to 27.

Aspect 29 is the apparatus of aspect 28, further including at least one network interface coupled to the at least one processor.

Aspect 30 is an apparatus for wireless communication at a network entity including means for implementing any of aspects 18 to 27.

Aspect 31 is a computer-readable medium (e.g., a non-transitory computer-readable medium) storing computer executable code, where the code when executed by a processor causes the processor to implement any of aspects 18 to 27.

What is claimed is:

1. An apparatus for wireless communication at a first user equipment (UE), comprising:
at least one memory; and
at least one processor coupled to the at least one memory, wherein the at least one processor is configured to:
transmit, to a network entity, an indication of at least one of:
(1) location information related to a second UE,
(2) a connection status of the first UE,
(3) a device type of the first UE,
(4) a radio frequency (RF) status of the first UE,
(5) a radio access technology (RAT) status of the first UE, or
(6) information related to other sidelink UEs or remote UEs; and
receive, from the network entity based on the indication, a set of configurations related to positioning of the first UE.

2. The apparatus of claim 1, wherein the at least one processor is further configured to:
perform the positioning of the first UE based on the set of configurations.

3. The apparatus of claim 1, wherein the first UE corresponds to a remote UE, the second UE corresponds to a relay UE, and the network entity corresponds to an access and mobility management function (AMF) or a location management function (LMF).

4. The apparatus of claim 1, wherein the indication includes the location information related to the second UE, and wherein the location information includes at least one of: a set of coordinates of the second UE, a cell identification (ID) associated with the second UE, or an E-UTRA absolute radio frequency channel number (EARFCN) associated with the second UE.

5. The apparatus of claim 1, wherein the indication includes the connection status of the first UE, and wherein the connection status includes at least one of: an idle state, a connected state, or a sleep state with a specified signaling type.

6. The apparatus of claim 1, wherein the indication includes the device type of the first UE, and wherein the device type includes at least one of: a mobile device, a reduced capability (RedCap) device, a wearable device, an Internet of Things (IoT) device, an automotive, or an unmanned aerial vehicle (UAV).

7. The apparatus of claim 1, wherein the indication includes the RF status of the first UE, and wherein the RF status includes at least one of: a reference signal received power (RSRP) associated with the first UE, a signal-to-noise ratio (SNR) associated with the first UE, a received signal strength indicator (RSSI) associated with the first UE, or a channel state information (CSI) associated with the first UE.

8. The apparatus of claim 1, wherein the indication includes the RAT status of the first UE, and wherein the RAT status includes at least one of: a support for a higher RAT compared to the second UE, a set of supported frequency ranges (FRs), a support for reduced capability (RedCap) device, or a support for non-terrestrial networks (NTN).

9. The apparatus of claim 1, wherein to transmit the indication, the at least one processor is configured to:
transmit the indication via a user-to-network (U2N) remote UE provide capability message.

10. The apparatus of claim 1, wherein to transmit, to the network entity, the indication, the at least one processor is configured to:
transmit the indication directly to the network entity, or transmit the indication to the network entity via the second UE.

11. The apparatus of claim 1, wherein to receive the set of configurations, the at least one processor is configured to:
receive the set of configurations via assistance data (AD).

12. The apparatus of claim 1, wherein the indication includes at least: (2) the connection status of the first UE and (3) the device type of the first UE.

13. The apparatus of claim 1, wherein the indication includes at least: (4) the RF status of the first UE and (5) the RAT status of the first UE.

14. A method of wireless communication at a first user equipment (UE), comprising:
transmitting, to a network entity, an indication of at least one of:
(1) location information related to a second UE,
(2) a connection status of the first UE,
(3) a device type of the first UE,
(4) a radio frequency (RF) status of the first UE,
(5) a radio access technology (RAT) status of the first UE, or
(6) information related to other sidelink UEs or remote UEs; and
receiving, from the network entity based on the indication, a set of configurations related to positioning of the first UE.

15. An apparatus for wireless communication at a network entity, comprising:
at least one memory; and
at least one processor coupled to the at least one memory, wherein the at least one processor is configured to:
receive an indication of at least one of:
(1) location information related to a second user equipment (UE),
(2) a connection status of a first UE,
(3) a device type of the first UE,
(4) a radio frequency (RF) status of the first UE,
(5) a radio access technology (RAT) status of the first UE, or
(6) information related to other sidelink UEs or remote UEs; and
transmit, based on the indication, a set of configurations related to positioning of the first UE.

16. The apparatus of claim 15, wherein the first UE corresponds to a remote UE, the second UE corresponds to a relay UE, and the network entity corresponds to an access and mobility management function (AMF) or a location management function (LMF).

17. The apparatus of claim 15, wherein the indication includes the location information related to the second UE, and wherein the location information includes at least one of: a set of coordinates of the second UE, a cell identification (ID) associated with the second UE, or an E-UTRA absolute radio frequency channel number (EARFCN) associated with the second UE.

18. The apparatus of claim 15, wherein the indication includes the connection status of the first UE, and wherein the connection status includes at least one of: an idle state, a connected state, or a sleep state with a specified signaling type.

19. The apparatus of claim 15, wherein the indication includes the device type of the first UE, and wherein the device type includes at least one of: a mobile device, a reduced capability (RedCap) device, a wearable device, an Internet of Things (IoT) device, an automotive, or an unmanned aerial vehicle (UAV).

20. The apparatus of claim 15, wherein the indication includes the RF status of the first UE, and wherein the RF status includes at least one of: a reference signal received power (RSRP) associated with the first UE, a signal-to-noise ratio (SNR) associated with the first UE, a received signal strength indicator (RSSI) associated with the first UE, or a channel state information (CSI) associated with the first UE.
